(19) United States
(12) Patent Application Publication
(10) Pub. No.: US 2021/0186250 A1
(43) Pub. Date: Jun. 24, 2021

(54) COOKING APPARATUS

(71) Applicant: LG Electronics Inc., Seoul (KR)

(72) Inventors: Wan Soo KIM, Seoul (KR); Hyeunsik NAM, Seoul (KR); Yangkyeong KIM, Seoul (KR)

(21) Appl. No.: 16/905,514

(22) Filed: Jun. 18, 2020

(30) Foreign Application Priority Data
Dec. 18, 2019 (KR) 10-2019-0170125

(51) Int. Cl. A47J 27/08; A47J 27/00; A47J 27/086; A47J 36/06

(52) U.S. Cl. CPC A47J 27/0802; A47J 27/002; A47J 36/06; A47J 27/086; A47J 27/004

(57) ABSTRACT

A cooking apparatus includes a chamber, a heater configured to heat the chamber, a pump configured to supply water into the chamber to thereby generate a pressure in the chamber, and a processor configured to control at least one of the heater or the pump based on a temperature of the chamber and the pressure in the chamber.

### CROSS-REFERENCE TO RELATED APPLICATION

This application claims priority to and the benefit of Korean Patent Application No. 10-2019-0170125, filed on Dec. 18, 2019, the disclosure of which is incorporated herein by reference in its entirety.

### TECHNICAL FIELD

The present disclosure relates to a cooking apparatus that forcibly injects water into a cooking space to generate a pressure and that performs a high-temperature cooking operation under the generated pressure.

### BACKGROUND

A pressure cooker may heat an object subject to cooking and water stored in a sealed inner space (e.g., an internal pot) together to evaporate the water. For example, when the water is evaporated in the inner space, a pressure in the inner space may be increased, and a boiling point of water may be also increased. When the boiling point is increased, the pressure cooker may cook the object in the inner space to a higher temperature. Using the method, the object may be cooked at a high temperature.

FIG. 1 is a view illustrating an example of a boiling point of water changing based on a gauge pressure. A cooking operation of the pressure cooker of the related art is described with reference to FIG. 1.

For example, the pressure cooker of the related art may heat an object and water stored in the inner space together under atmospheric pressure (a gauge pressure of 0 kPa). When a temperature of the heated water reaches 100 degrees Celsius, the water may be evaporated, an air pressure in the inner space is gradually increased to about 2 atm (a gauge pressure of about 101 kPa), and a boiling point of the water in the inner space may be increased to about 120 degrees Celsius. Due to the increased boiling point, the pressure cooker may heat the object in the inner space to about 120 degrees Celsius, and the object may be heated and cooked at a high temperature of about 120 degrees Celsius.

As described above, in the pressure cooker of the related art, steam generated through the heating of water may be used as a means to create a pressure for raising a boiling point of water. That is, in the pressure cooker of the related art, as a pressure is generated only after water is evaporated, the object may not be cooked at a high temperature from the beginning. Thus, it may take a long time to cook the object.

In some cases, a cooking apparatus may create a pressure in a cooking space using an additional pressure booster.

FIGS. 2A and 2B illustrate a cooking apparatus of the related art that includes a lid 20 that opens and closes a cooking cavity 11 and a pressure booster 30 installed in the lid 20.

The pressure booster 30 may communicate with an intake port 23, and air outside of the cooking cavity 11 may be suctioned into the cooking cavity 11 through the intake port 23 by the pressure booster 30, and may increase an air pressure of the cooking cavity 11.

In some cases, gas may be used as a means to generate a pressure in the cooking space. Since gas has high compressibility, and it may take a long time to generate a pressure in the cooking space using gas.

In some cases, where gas has high expandability, and a sufficient pressure may not be generated in the cooking space for safety reasons. For instance, referring to FIG. 2A, external air is suctioned and compressed to create a pressure in the cooking cavity 11. As the pressure in the cooking cavity 11 is increased, expandability of compressed air is increased. In some cases, the lid 20 may be exploded.

In some cases, where steam is generated through evaporation of water, a user may have difficulty in finding an amount of water to be evaporated in the cooking space. The user may learn how to adjust an amount of water to be stored together with an object by trial and error in which the quality of a cooked object may not be ensured.

### SUMMARY

The present disclosure is directed to a cooking apparatus that may perform a cooking operation under a high-pressure environment that is created by forcibly supplying water.

The present disclosure is also directed to a cooking apparatus that may adjust a moisture content of an object subject to cooking.

The present disclosure is also directed to a cooking apparatus that may condense steam discharged after a cooking operation.

Aspects of the present disclosure are not limited to the above-described ones. Additionally, other aspects and advantages that have not been mentioned may be clearly understood from the following description and may be more clearly understood from implementations. Further, it will be understood that the aspects and advantages of the present disclosure may be realized via means and combinations thereof that are described in the appended claims.

According to one aspect of the subject matter described in this application, a cooking apparatus includes a chamber, a heater configured to heat the chamber, a pump configured to supply water into the chamber to thereby generate a pressure in the chamber, and a processor configured to control at least one of the heater or the pump based on a temperature of the chamber and the pressure in the chamber.

Implementations according to this aspect may include one or more of the following features. For example, the cooking apparatus may further include a lid that may be configured to open and close the chamber. In some implementations, the heater may include a coil disposed at an outer surface of the chamber and configured to heat the chamber through a magnetic field generated in the coil.

In some implementations, the pump may be configured to supply additional water into the chamber that is filled with water to thereby generate the pressure in the chamber. For instance, the pump may forcibly supply water into the chamber after the chamber is filled with water to a predetermined full level of the chamber.

In some implementations, the cooking apparatus may further include a countercurrent prevention valve that is disposed between the pump and the chamber and that may be configured to restrict backflow of water from the chamber to the pump. In some implementations, the cooking apparatus may further include a pressure sensor that is disposed in a flow path between the pump and the chamber and that may be configured to sense the pressure in the chamber.

In some implementations, the cooking apparatus may further include a temperature sensor that is disposed at an outer surface of the chamber and that may be configured to sense the temperature of the chamber. In some implementations, the cooking apparatus may further include a pressure release valve that may be configured to release the pressure generated in the chamber. In some examples, the processor may be configured to control the pump to supply water into the chamber in a state in which the pressure release valve is opened, and block the pressure release valve based on the chamber being filled with water to a full level.

In some examples, the processor may be configured to control a degree to which the pressure release valve is opened. In some examples, the cooking apparatus may further include a gas-liquid separator that may be configured to separate water and steam discharged through the pressure release valve. In some examples, the cooking apparatus may further include a condenser that may be configured to condense steam discharged through the pressure release valve.

In some implementations, the processor may be configured to control the pump to supply water into the chamber until the pressure in the chamber reaches a predetermined pressure. In some implementations, the processor may be configured to control the heater to increase the temperature of the chamber to a predetermined temperature. In some implementations, the processor may be configured to control the heater to increase the temperature of the chamber a target temperature that is lower than a boiling point corresponding to the pressure in the chamber.

In some implementations, the processor may be configured to control the pump to supply water into the chamber until the pressure in the chamber reaches a predetermined pressure, and then control the heater to increase the temperature of the chamber to a target temperature that is lower than a boiling point corresponding to the predetermined pressure. In some examples, the processor may be configured to maintain the pressure in the chamber at the predetermined pressure while controlling the heater to increase the temperature of the chamber to the target temperature.

In some implementations, the cooking apparatus may further include a pressure release valve that may be configured to release the pressure generated in the chamber, and the processor may be configured to, based on the temperature of the chamber corresponding to the target temperature, open at least a portion of the pressure release valve to a predetermined degree to thereby evaporate at least a portion of pressurized water in the chamber.

In some implementations, the processor may be configured to control the pump to supply water into the chamber to increase the pressure in the chamber to a predetermined pressure while controlling the heater to increase the temperature of the chamber to a target temperature that is lower than a boiling point corresponding to the pressure in the chamber.

In some examples, the cooking apparatus may further include a pressure release valve that may be configured to release the pressure generated in the chamber, where the processor may be configured to, based on the temperature of the chamber corresponding to the target temperature, open at least a portion of the pressure release valve to a predetermined degree to thereby evaporate at least a portion of pressurized water in the chamber.

In some implementations, the cooking apparatus may heat a chamber and performs an operation of cooking an object after a high pressure is generated in the chamber by forcibly injecting water into the chamber where the object is stored.

In some implementations, the cooking apparatus may adjust a moisture content of an object by controlling a speed at which high-temperature high-pressure water filling a chamber is discharged.

In some implementations, the cooking apparatus may condense steam into water again when high-temperature high-pressure water filling a chamber is turned into the steam.

In some implementations, the cooking apparatus may perform a cooking operation in a high-pressure environment that is created by forcibly supplying water, thereby making it possible to create a high-pressure environment rapidly in order to shorten a cooking period and to heat an object to a high temperature in order to ensure quality cooking for the object.

In some implementations, it may be possible to ease the cumbersome process of adjusting an amount of water previously for a cooking operation and to guarantee quality cooking to meet the taste of the user.

In some implementations, the cooking apparatus may condense steam that is discharged after a cooking operation, thereby reducing noise caused by the discharge of steam after the cooking operation and helping to prevent danger caused by the discharge of high-temperature steam.

Detailed effects of the present disclosure are described together with the above-described effects in the detailed description of the disclosure.

### BRIEF DESCRIPTION OF THE DRAWINGS

FIG. 1 is a view illustrating an example of a boiling point of water changing based on a gauge pressure in related art.

FIG. 2A and FIG. 2B are views illustrating an example of a pressure cooker in related art.

FIG. 3 is a block diagram illustrating example components of an example of a cooling apparatus.

FIG. 4 is a view illustrating an example of a cooking apparatus.

FIG. 5 is a view illustrating an example of a change in temperatures and pressures during an example cooking process.

FIG. 6 is a view illustrating an example of a change in temperatures and pressures during an example cooking process.

### DETAILED DESCRIPTION

The above-described aspects, features and advantages are specifically described with reference to the accompanying drawings hereunder such that one having ordinary skill in the art to which the present disclosure pertains may easily implement the technical spirit of the disclosure. Below, one or more implementations of the present disclosure are specifically described with reference to the accompanying drawings. Throughout the drawings, identical reference numerals denote identical or similar components.

The present disclosure relates to a cooking apparatus that forcibly injects water into a cooking space to create a pressure and performs a high-temperature cooking operation under the created pressure.

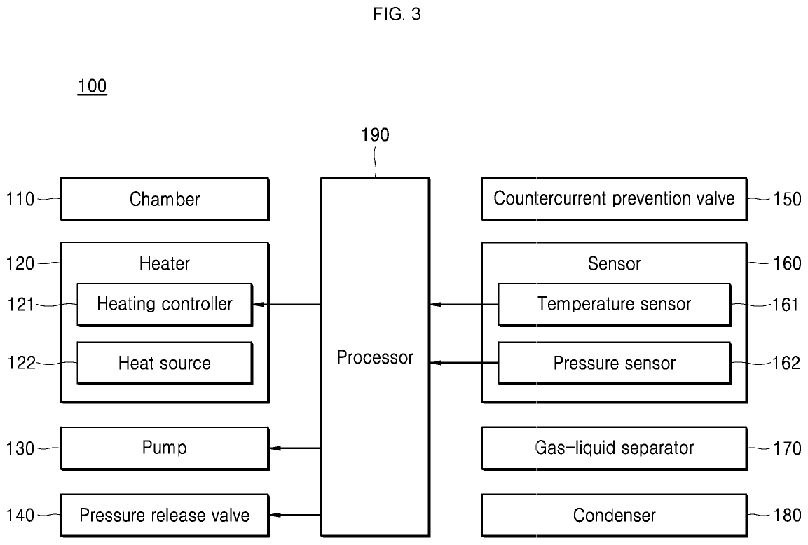

Below, an example of a cooking apparatus is described with reference to FIGS. 3 to 5.

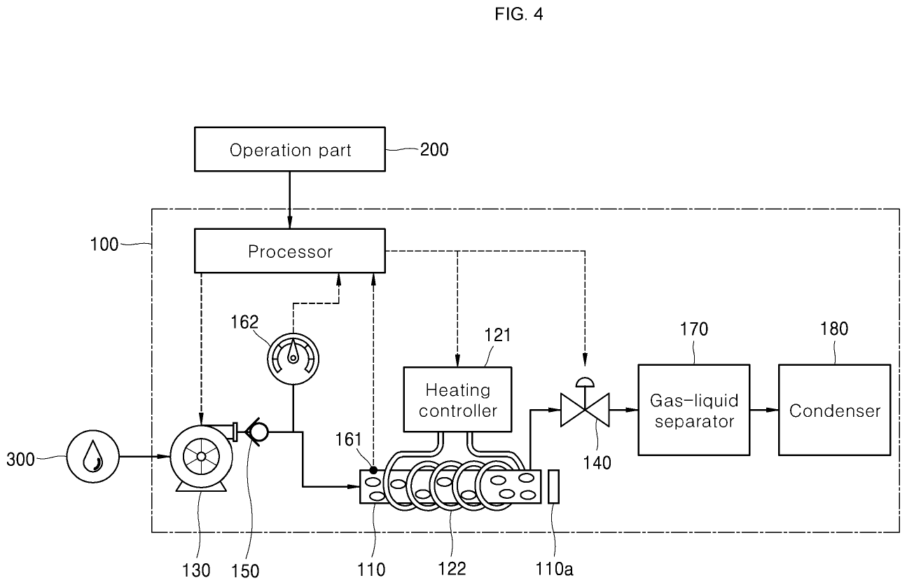

FIG. 3 is a block diagram illustrating example components of an example cooling apparatus, and FIG. 4 is a view illustrating an example cooking apparatus.

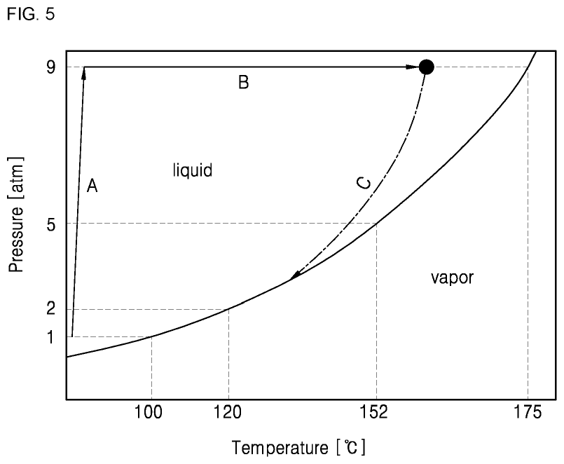

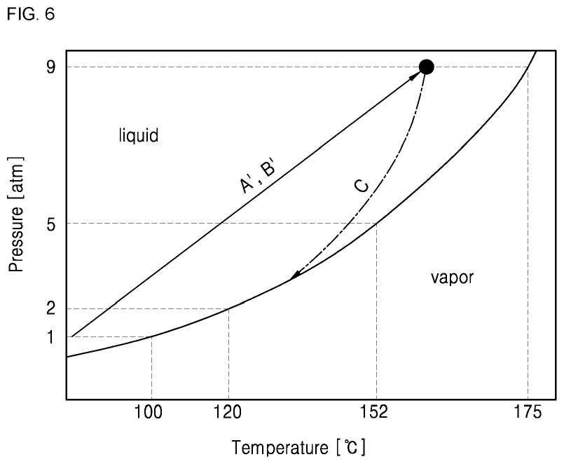

FIGS. 5 and 6 are views illustrating examples of a change in temperatures and pressures during example cooking processes.

In some implementations, referring to FIGS. 3 and 4, a cooking apparatus 100 may include a chamber 110, a heater 120, a pump 130, a pressure release valve 140, a countercurrent prevention valve 150, a sensor 160, a gas-liquid separator 170, a condenser 180, and a processor 190. The cooking apparatus 100 illustrated in FIGS. 3 and 4 is provided according to an implementation, and components of the cooking apparatus 100 are not limited to those of the implementation in FIGS. 3 and 4. When necessary, some components may be added, modified or removed.

In some implementations, the cooking apparatus 100 may further include a memory that is implemented as a read-only memory (ROM), a random access memory (RAM), an erasable programmable read-only memory (EPROM), a flash drive, a hard drive and the like. In the memory, programs for operations of the processor 190 and various data for entire operations of the cooking apparatus 100 may be stored. The memory may be a non-transitory memory device.

The chamber 110 may be implemented as a hollow shape having an inner space. For example, the chamber 110 may have a hollow cylinder shape or may have a hollow polygonal prism shape. An object such as grain and the like may be stored in the inner space of the chamber 110, and the object may be cooked in the inner space of the chamber 110. For instance, the chamber 110 may be a pot of the cooking apparatus 100.

The chamber 110 may further include a lid 110a. The lid 110a may be configured to be open and close the chamber 110 and connected to one end of the chamber 110 to shield the inner space of the chamber 110 from the outside. For instance, when the lid 110a is opened, an object (e.g., grains, meats, and other types of food) subject to cooking may be received in the inner space of the chamber 110, and the object in the chamber 110 may be cooked with the lid 110a closed.

The object in the chamber 110 may be cooked through a heating process. For example, the cooking apparatus 100 may include a heater 120 to heat the object.

The heater 120 may heat the chamber 110 and, the heated chamber 110 may deliver heat to the object therein. The heater 120 may include a heat source 122, and a heating controller 121 for controlling the heat source 122.

The heat source 122 may be implemented in various different forms. For example, the heat source 122 may be implemented as a gas burner that produces a flame or may be implemented as a coil 122 that generates a magnetic field. In addition, the heat source 122 may be implemented in various different forms that may heat the chamber 110. Below, a heat source 122 implemented as a coil 122 is described for convenience of description.

The heater 120 may include a coil 122 provided on an outer surface of the chamber 110, and may heat the chamber 110 through a magnetic field generated in the coil 122. Referring back to FIG. 4, the coil 122 may be configured to turn and wrap around the outer surface of the chamber 110 a plurality of times. One end and the other end of the coil 122 may be electrically connected to the heating controller 121, and the heating controller 121 may supply electric currents to the coil 122 to heat the chamber 110.

In some examples, the heating controller 121 in the heater 120 may supply electric currents to the coil 122. By doing so, a magnetic field may be generated in the coil 122. The magnetic field generated in the coil 122 may induce electric currents to the chamber 110, and the electric currents induced to the chamber 110 may generate Joule's heat to heat the chamber 110. The operation of supplying electric currents performed by the heating controller 121 may be controlled by a processor 190. Description in relation to this is provided hereunder.

For generation of induced currents, the chamber 110 may include any material having magnetic properties. The chamber 110, for example, may include cast iron including iron (Fe), or clad in which iron (Fe), aluminum (Al), and stainless steel and the like are welded.

In some examples, cooking performance may be improved when an object is heated at a high temperature in a state where the object contains water. In some cases, when the object is heated at a high temperature, water contained in the object may be evaporated, and a moisture content of the object may be decreased. Accordingly, a temperature at which an object is heated may be controlled to a temperature lower than a boiling point of water.

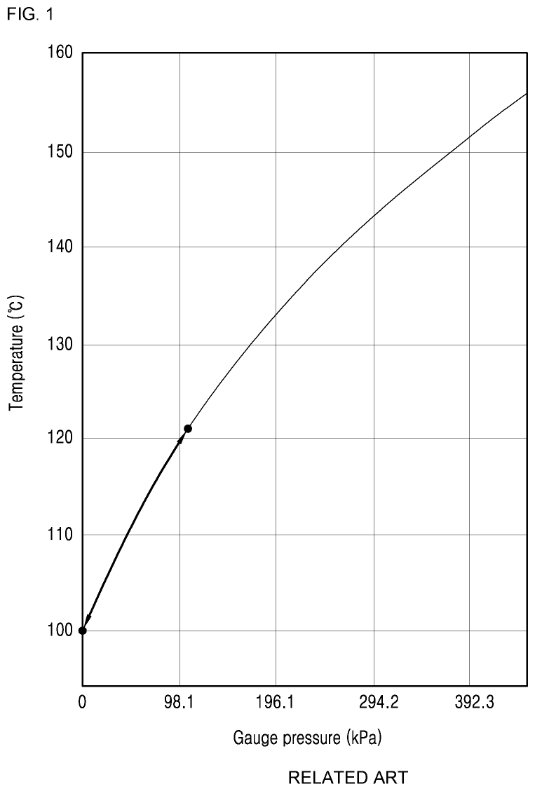

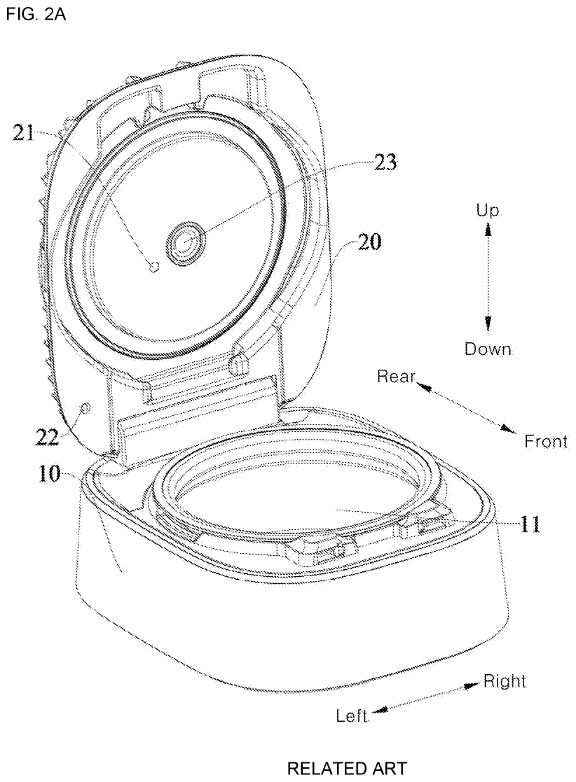

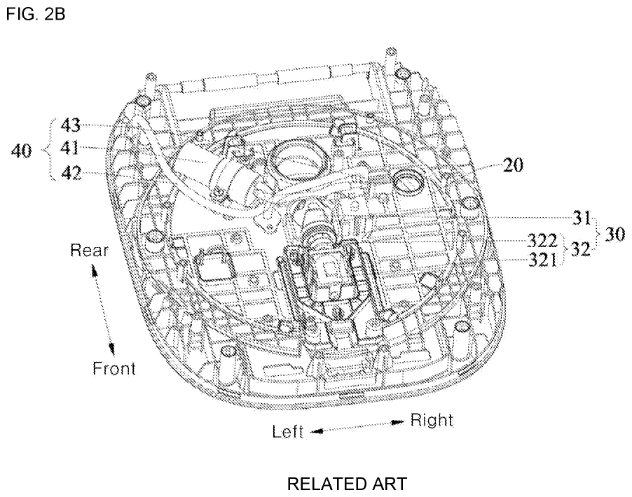

As described above with reference to FIG. 1, a boiling point of water increases based on an increase in pressure. Accordingly, to heat an object at a high temperature, a pressure in a space where the object is stored needs to be increased. The cooking apparatus 100 of the present disclosure may include a pump 130 to increase the pressure.

For instance, the pump 130 may supply water into the chamber 110 to generate a pressure in the chamber 110. Specifically, one end of the pump 130 may be connected to an external water supply 300, and the other end may be connected to an inside of the chamber 110 to supply water supplied by the external water supply 300 into the chamber 110.

A pressure in the chamber 110 may be generated only by water supplied by the pump 130. In some examples, the operation of supplying water by the pump 130 may performed in a state in which the inner space of the chamber 110 is sealed and the chamber 110 is full of water. For example, the pump 130 may be configured to supply additional water into the chamber that is filled with water to a predetermined full level of water in the chamber.

The inner space of the chamber 110 may be filled with an object and air before the pump 130 supplies water into the chamber. When water starts to be supplied to the chamber in a state where the chamber 110 is not sealed (e.g., when the above-described lid 110a is opened), the air filling the inner space of the chamber 110 may be discharged from the chamber 110, and the inner space of the chamber 110 may be filled with water.

When the inner space of the chamber 110 is full of water, the lid 110a of the chamber 110 may be closed, and the pump 130 may forcibly supply water to the inner space of the chamber 110 that has already been filled with water. By the water that is forcibly supplied to the chamber, a pressure in the chamber 110 may be increased. An increased amount of the pressure may be determined based on an amount of forcibly supplied water.

The cooking apparatus 100 may include a countercurrent prevention valve 150 between the pump 130 and the chamber 110 to help to prevent water from leaking from the inside of the chamber 110 towards the pump 130 due to an increase in pressures in the chamber 110.

The countercurrent prevention valve 150 may be provided on a flow path that connects the pump 130 and the chamber 110, and may help to prevent the water in the chamber 110 from flowing backwards to the pump 130. The countercurrent prevention valve 150 may be implemented as various forms of valves that are used in the art to which the disclosure pertains. For example, the countercurrent prevention valve 150 may be a check valve that allows flow in one direction and that restricts flow in another direction.

The above-described method by which water is forcibly injected to create a pressure in the chamber 110 may generate a higher pressure more rapidly than a method of the related art by which steam is used to create a pressure. When a high pressure is generated in the chamber 110, a boiling point of water that fills the chamber 110 is increased, and a temperature at which an object is heated may also be increased. Accordingly, cooking performance may be improved.

Referring to the related art shown in FIG. 1, a pressure in a space, where cooking is performed using steam, may be increased to approximately 2 atm (a gauge pressure of 101 kPa), and then an object is cooked. Accordingly, a temperature, at which the object may be cooked, may be limited to about 120 degrees Celsius that is a boiling point of water based on a pressure of 2 atm. Due to the temperature limitations, a cooking period becomes longer, and the quality of a cooked object may be deteriorated.

According to the present disclosure, water rather than steam is used to easily increase a pressure in the chamber 110 to 9 atm. Accordingly, a temperature, at which an object may be cooked, may be increased to about 175 degrees Celsius that is a boiling point of water based on 9 atm. Because of an increase in the heating temperature, an object may be rapidly cooked and the quality of the cooked object may be improved.

For the high-temperature high-pressure cooking operation, the processor 190 may control at least one of the above-described heater 120 and the pump 130 based on a temperature of the chamber 110 and a pressure in the chamber 110.

In some implementations, operations of the heater 120 and the pump 130 may be controlled by the processor 190, and the processor 190 may control the heater 120 and the pump 130 based on the current temperature of the chamber 110 and the current pressure generated in the chamber 110. To this end, the processor 190 may monitor the temperature of the chamber 110 and the pressure in the chamber 110 through the sensor 160.

In some implementations, the processor 190 may include at least one physical component among an electric circuit, application specific integrated circuits (ASICs), digital signal processors (DSPs), digital signal processing devices (DSPDs), programmable logic devices (PLDs), field programmable gate arrays (FPGAs), processors, controllers, micro-controllers, or microprocessors.

In some implementations, the cooking apparatus 100 may include a pressure sensor 162 provided at a flow path between the pump 130 and the chamber 110 and configured to sense a pressure in the chamber 110, and may include a temperature sensor 161 provided on the outer surface of the chamber 110 and configured to sense a temperature of the chamber 110. Positions of the pressure sensor 162 and the temperature sensor 161 are exemplarily illustrated. When necessary, the pressure sensor 162 and the temperature sensor 161 may be provided at different positions in designing a cooking apparatus.

The pressure sensor 162 may sense a hydraulic pressure of water flowing on the flow path between the pump 130 and the chamber 110 to sense a pressure in the chamber 110. The temperature sensor 161 may sense a temperature of the outer surface of the chamber 110 to sense a temperature of the chamber 110. The pressure sensor 162 and the temperature sensor 161 maybe digital sensors and may provide a sensed pressure and a sensed temperature to the processor 190.

The processor 190 may control the pump 130 such that the pump 130 supplies water into the chamber 110 until a pressure in the chamber 110, sensed by the pressure sensor 162, reaches a predetermined pressure. The predetermined pressure may be determined through experiments to guarantee excellent cooking performance and quality cooking with respect to an object. For example, the predetermined pressure may be 9 atm.

Specifically, the processor 190 may compare a pressure in the chamber 110, sensed by the pressure sensor 162, with a predetermined pressure stored in the memory. In case the pressure in the chamber 110 is lower than the predetermined pressure as a result of comparison, the processor 190 may provide a control signal to the pump 130, and the pump 130 may operate based on the control signal supplied by the processor 190 and may supply water into the chamber 110 forcibly.

The processor 190 may continue to compare a pressure in the chamber 110, sensed by the pressure sensor 162, with a predetermined pressure stored in the memory. When the pressure in the chamber 110 reaches the predetermined pressure, the processor 190 may cut off the supply of a control signal, and the pump 130 may cut off the supply of water.

Further, the processor 190 may control the heater 120 such that the heater 120 heats the chamber 110 until a temperature of the chamber 110, sensed by the temperature sensor 161, reaches a predetermine temperature. The predetermined temperature may be determined through experiments to guarantee excellent cooking performance and quality cooking with respect to an object.

Specifically, the processor 190 may compare a temperature of the chamber 110, sensed by the temperature sensor 161, with a predetermined temperature stored in the memory. In case the temperature of the chamber 110 is lower than the predetermined temperature as a result of comparison, the processor 190 may provide a control signal to the heating controller 121, and the heating controller 121 may operate based on the control signal supplied by the processor 190 and may supply electric currents to the coil 122. By the electric currents supplied to the coil 122, induced currents may be generated in the chamber 110, and the chamber 110 may be heated by Joule's heat caused by the induced currents.

The processor 190 may continue to compare a temperature of the chamber 110, sensed by the temperature sensor 161, with a predetermined temperature stored in the memory. In case the temperature of the chamber 110 reaches the predetermined temperature, the processor 190 may cut off the supply of a control signal, and the heating controller 121 may cut off the supply of electric currents.

The predetermined temperature may be determined based on a boiling point based on a pressure in the chamber 110. Specifically, the predetermined temperature may be determined not to exceed a boiling point based on a pressure in the chamber 110. That is, when the chamber 110 is heated using the above-described method, the processor 190 may control the heater 120 such that the temperature of the chamber 110 does not exceed a boiling point based on the pressure in the chamber 110.

Below, example cooking processes will be described with reference to FIGS. 5 and 6.

In some implementations, referring to FIG. 5, a processor 190 may control a pump 130 such that the pump 130 supplies water into a chamber 110 until a pressure in the chamber 110 reaches a predetermined pressure. Then, the processor 190 may control a heater 120 such that a temperature of the chamber 110 does not exceed a boiling point based on the predetermined pressure. For instance, the processor 190 may control the heater 120, while maintaining the predetermined pressure in the chamber 110, to increase the temperature of the chamber 110 to a target temperature that is lower than the boiling point.

For instance, the processor 190 may provide a control signal to the pump 130 until a pressure in the chamber 110 reaches 9 atm. The pump 130 may forcibly supply water into the chamber 110 based on the control signal provided by the processor 190, and the pressure in the chamber 110 may be gradually increased to 9 atm (A).

When the pressure in the chamber 110 reaches 9 atm, the processor 190 may provide a control signal to a heating controller 121 until a temperature of the chamber 110 reaches 160 degrees Celsius that does not exceeds a boiling point (about 175 degrees Celsius) based on 9 atm. The heating controller 121 may supply electric currents to a coil 122 based on the control signal provided by the processor 190 to heat the chamber 110, and the temperature of the chamber 110 is gradually increased to 160 degrees Celsius (B).

The processor 190 may continue to monitor a pressure in the chamber 110 and a temperature of the chamber 110 through a pressure sensor 162 and a temperature sensor 161. According to the above-described control method of the pump 130 and the heater 120, the processor may maintain the pressure in the chamber 110 at a pressure of 9 atm and maintain the temperature of the chamber 110 at a temperature of 160 degrees Celsius.

In some implementations, referring to FIG. 6, a processor 190 may control a pump 130 such that the pump 130 supplies water into a chamber 110 until a pressure in the chamber 110 reaches a predetermined pressure, and, at the same time, may control a heater 120 such that a temperature of the chamber 110 does not exceed a boiling point based on the current pressure in the chamber 110. For instance, the processor 190 may be configured to control the pump 130 to supply water into the chamber 110 to increase the pressure in the chamber 110 to the predetermined pressure while controlling the heater 120 to increase the temperature of the chamber 110 to a target temperature that is lower than the boiling point corresponding to the pressure in the chamber.

For example, the processor 190 may provide a control signal to the pump 130 until a pressure in the chamber 110 reaches 9 atm. The pump 130 may forcibly supply water into the chamber 110 based on the control signal provided by the processor 190, and the pressure in the chamber 110 may be slowly increased (A′).

At the same time, the processor 190 may provide a control signal to a heating controller 121 such that a temperature of the chamber 110 is increased within a range where the temperature of the chamber 110 does not exceed a boiling point based on an increasing pressure in the chamber 110. The heating controller 121 may supply electric currents to a coil 122 based on the control signal provided by the processor 190 to heat the chamber 110, and the temperature of the chamber 110 may be gradually increased (B′).

That is, the operation of generating a high pressure in the chamber 110 and the operation of heating the chamber 110 to a high temperature may be performed simultaneously. Accordingly, as illustrated in FIG. 6, a pressure in the chamber 110 and a temperature of the chamber 110 are gradually increased. Thus, the temperature of the chamber 110 may reach 160 degrees Celsius at a time point when the pressure in the chamber 110 reaches 9 atm.

In some examples, an object in the chamber 110 may be heated and cooked for a predetermined period in a high-temperature high-pressure state that is created according to the above-described method.

The present disclosure, as described above, may perform a cooking operation under a high-pressure environment that is created by forcibly supplying water. Accordingly, the high-pressure environment may be rapidly created and a cooking period may be shortened. Additionally, an object may be heated to a higher temperature, thereby ensuring quality cooking for the object.

The cooking apparatus 100 may further include a pressure release valve 140 to release the pressure generated in the chamber 110 after the object is cooked.

As illustrated in FIG. 4, the pressure release valve 140 may be connected to the inner space of the chamber 110, and may optionally leak water filling the chamber 110 to release the pressure generated in the chamber 110.

The pressure release valve 140 may be controlled by the processor 190. That is, the processor 190 may block the pressure release valve 140 before the above-described cooking operation and may open the pressure release valve 140 after the cooking operation.

For example, during the process of generating a pressure in the chamber 110 for cooking an object, the processor 190 may control the pump 130 such that the pump 130 supplies water into the chamber 110 after the pressure release valve 140 is opened. Accordingly, air filling the chamber 110 may leak outwards through the pressure release valve 140. Then when the chamber 110 is full of water, the processor 190 may block the pressure release valve 140 and may control the pump 130 such that the pump 130 continues to supply water into the chamber 110 to generate a pressure in the chamber 110.

After the cooking operation, the processor 190 may open the pressure release valve 140 to discharge the water filling the chamber 110.

Referring back to FIGS. 5 and 6, when the pressure release valve 140 is opened, the pressure in the chamber 110 is decreased (C), and, due to a decrease in a boiling point caused by the decreased pressure, water having been heated to a high temperature may be turned into steam. In this case, the temperature in the chamber 110 may be decreased by evaporation heat of the water (C).

A speed at which water is evaporated when the pressure release valve 140 is opened may be determined based on a degree to which the pressure release valve 140 is opened, and, based on the speed at which water is evaporated, a moisture content of an object may be determined.

Specifically, in case water leaks rapidly out of the chamber 110 as the pressure release valve 140 is wide open (when a large amount of water is evaporated), a moisture content of an object may be decreased. In case water leaks slowly out of the chamber 110 as the pressure release valve 140 is narrowly opened (when a small amount of water is evaporated), a moisture content of an object may be increased.

Accordingly, the processor 190 may control a degree to which the pressure release valve 140 is opened to adjust a moisture content.

For example, the processor 190 may control the degree to which the pressure release valve 140 is opened based on a predetermined moisture content. The predetermined moisture content may be determined through experiments to guarantee quality cooking for an object.

Additionally, the processor 190 may control the degree to which the pressure release valve 140 is opened according to a user's instruction.

Referring to FIG. 4, the user may input a user instruction in relation to a moisture content through any operation part 200. For example, user A may input a user instruction for cooking al dente rice through the operation part 200, and the input user instruction may be provided to the processor 190.

The processor 190 may open the pressure release valve 140 at a ratio higher than a reference ratio based on the user instruction after the cooking operation is finished. Accordingly, a moisture content of the rice may be lower than the predetermined moisture content such that al dente rice is cooked.

User B may input a user instruction for cooking soft rice through the operation part 200, and the input user instruction may be provided to the processor 190.

The processor 190 may open the pressure release valve 140 at a ratio lower than the reference ratio based on the user instruction after the cooking operation is finished. Accordingly, a moisture content of the rice may be higher than the predetermined moisture content such that soft rice is cooked.

The present disclosure, as described above, may adjust a moisture content of an object, thereby making it possible to ease the cumbersome process of adjusting an amount of water previously for a cooking operation and to guarantee quality cooking to meet the taste of the user.

In some implementations, the cooking apparatus 100 may further include a gas-liquid separator 170 that separates water and steam discharged through the pressure release valve 140.

As described above, when the pressure release valve 140 is opened, water may be turned into steam. However, when a predetermined period passes after the pressure release valve 140 is opened, the temperature in the chamber 110 may be decreased by evaporation heat of water, and the water may be no longer evaporated. Accordingly, water as well as steam may be discharged through the pressure release valve 140.

The gas-liquid separator 170 may be connected to an output port of the pressure release valve 140 and may separate water and steam discharged through the pressure release valve 140 structurally. The gas-liquid separator 170 may be implemented through various devices that are used in the art to which the disclosure pertains. For instance, the gas-liquid separator 170 may include a vessel or a reservoir having an inlet configured to receive mixture of gas and liquid and an outlet configured to discharge gas separated from the mixture.

The steam structurally separated through the gas-liquid separator 170 may be discharged to the atmosphere, and the water may be collected through an additional pipe.

In some implementations, the cooking apparatus 100 may further include a condenser 180 that condenses steam discharged through the pressure release valve 140.

The condenser 180 may be connected to the output port of the pressure release valve 140 or may be connected to an output port of the gas-liquid separator. The condenser 180 may condense steam having a relatively large volume into water having a relatively small volume. The condenser 180 may be implemented through various devices that are used in the art to which the disclosure pertains.

The present disclosure, as described above, may condense steam that is discharged after the cooking operation, thereby reducing noise caused by the discharge of steam after the cooking operation and helping to prevent danger caused by the discharge of high-temperature steam.

The present disclosure described above may be replaced, modified and changed in various different forms by one having ordinary skill in the art to which the present disclosure pertains without departing from the technical spirit of the disclosure. Thus, the disclosure is not limited to the above-described implementations and the accompanying drawings.

What is claimed is:

1. A cooking apparatus, comprising:
a chamber;
a heater configured to heat the chamber;
a pump configured to supply water into the chamber to thereby generate a pressure in the chamber; and
a processor configured to control at least one of the heater or the pump based on a temperature of the chamber and the pressure in the chamber.

2. The cooking apparatus of claim 1, further comprising a lid that is configured to open and close the chamber.

3. The cooking apparatus of claim 1, wherein the heater comprises a coil disposed at an outer surface of the chamber and configured to heat the chamber through a magnetic field generated in the coil.

4. The cooking apparatus of claim 1, wherein the pump is configured to supply additional water into the chamber that is filled with water to thereby generate the pressure in the chamber.

5. The cooking apparatus of claim 1, further comprising a countercurrent prevention valve that is disposed between the pump and the chamber and that is configured to restrict backflow of water from the chamber to the pump.

6. The cooking apparatus of claim 1, further comprising a pressure sensor that is disposed in a flow path between the pump and the chamber and that is configured to sense the pressure in the chamber.

7. The cooking apparatus of claim 1, further comprising a temperature sensor that is disposed at an outer surface of the chamber and that is configured to sense the temperature of the chamber.

8. The cooking apparatus of claim 1, further comprising a pressure release valve that is configured to release the pressure generated in the chamber.

9. The cooking apparatus of claim 8, wherein the processor is configured to:
control the pump to supply water into the chamber in a state in which the pressure release valve is opened, and
block the pressure release valve based on the chamber being filled with water to a full level.

10. The cooking apparatus of claim 8, wherein the processor is configured to control a degree to which the pressure release valve is opened.

11. The cooking apparatus of claim 8, further comprising a gas-liquid separator that is configured to separate water and steam discharged through the pressure release valve.

12. The cooking apparatus of claim 8, further comprising a condenser that is configured to condense steam discharged through the pressure release valve.

13. The cooking apparatus of claim 1, wherein the processor is configured to control the pump to supply water into the chamber until the pressure in the chamber reaches a predetermined pressure.

14. The cooking apparatus of claim 1, wherein the processor is configured to control the heater to increase the temperature of the chamber to a predetermined temperature.

15. The cooking apparatus of claim 1, wherein the processor is configured to control the heater to increase the temperature of the chamber a target temperature that is lower than a boiling point corresponding to the pressure in the chamber.

16. The cooking apparatus of claim 1, wherein the processor is configured to control the pump to supply water into the chamber until the pressure in the chamber reaches a predetermined pressure, and then control the heater to increase the temperature of the chamber to a target temperature that is lower than a boiling point corresponding to the predetermined pressure.

17. The cooking apparatus of claim 16, wherein the processor is configured to maintain the pressure in the chamber at the predetermined pressure while controlling the heater to increase the temperature of the chamber to the target temperature.

18. The cooking apparatus of claim 17, further comprising a pressure release valve that is configured to release the pressure generated in the chamber,
wherein the processor is configured to, based on the temperature of the chamber corresponding to the target temperature, open at least a portion of the pressure release valve to a predetermined degree to thereby evaporate at least a portion of pressurized water in the chamber.

19. The cooking apparatus of claim 1, wherein the processor is configured to control the pump to supply water into the chamber to increase the pressure in the chamber to a predetermined pressure while controlling the heater to increase the temperature of the chamber to a target temperature that is lower than a boiling point corresponding to the pressure in the chamber.

20. The cooking apparatus of claim 19, further comprising a pressure release valve that is configured to release the pressure generated in the chamber,
wherein the processor is configured to, based on the temperature of the chamber corresponding to the target temperature, open at least a portion of the pressure release valve to a predetermined degree to thereby evaporate at least a portion of pressurized water in the chamber.
